(19) United States
(12) Patent Application Publication
(10) Pub. No.: US 2003/0093663 A1
(43) Pub. Date: May 15, 2003

(54) Technique to bootstrap cryptographic keys between devices

(76) Inventor: Jesse R. Walker, Portland, OR (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/007,865

(22) Filed: Nov. 9, 2001

(51) Int. Cl. H04L 9/00

(52) U.S. Cl. 713/150

(57) ABSTRACT

A technique to bootstrap a secure communications channel between devices via a cryptographic key. A key is generated by a first device and a copy of the key is sent to a second device via a short range wireless communication channel so as to provide each device with a shared key. In one embodiment, the short range channel comprises a transponder/transponder reader pair in which the transponder is placed in proximity to the transponder reader to enable communication between the devices. Upon receipt of the shared key, symmetric authenticated key agreement algorithms, one for each device, are executed to cooperatively generate a cryptographic key that is used to provide for a secure communication channel using an encrypted communication protocol based on the cryptographic key. The invention removes the necessity of entering userIDs, passwords, and the like at devices to enable the creation of shared cryptographic keys.

### BACKGROUND OF THE INVENTION

1. Field of the Invention

The present invention concerns secure communications channels in general, and, in particular, a technique for bootstrapping cryptographic keys between devices, wherein the cryptographic key is shared by the devices and used to establish a secure communication channel using an encrypted data protocol based on the cryptographic key.

2. Background Information

There are many instances in which it is desired to establish a “secure” communication channel between two or more devices. This can typically be done through use of well-known encryption techniques, wherein data is transmitted between devices in an encrypted form, and each device stores or otherwise has access to a shared cryptographic key that is used to decrypt the encryption data so that it may be provided to users in a human-readable form.

In order to have such a secure communication channel, there needs to be a way to initialize or “bootstrap” the channel. By necessity, each device needs to have an appropriate cryptographic key. In some secure channels, a pair of cryptographic keys are used, wherein the data sent in one direction uses a different cryptographic key than the data sent in the other direction. More commonly, however, is the use of a single cryptographic key that is shared by all of the devices that communicate over the secure communication channel.

In order to use a shared cryptographic key, there needs to be a mechanism for providing that key to each device. One potential way to establish a shared cryptographic key is to generate or select a cryptographic key and send the cryptographic key to the devices that will be sharing the key using a non-secure communication channel. For example, if device A and device B are linked in communication over a computer network, a user of device A could define a cryptographic key (or other unique identifier upon which such a key could be based), and send a copy of the cryptographic key to device B via the computer network. However, a significant problem with this approach concerns the ease with which data sent via non-secure communication channels, such as the cryptographic key, can be intercepted or “stolen” by hackers or other third parties. Since the number of commonly-used encrypted communication protocols is finite, once a third party has a cryptographic key, it is possible for them to intercept supposedly secure communications and decrypt them.

A common method for establishing a shared cryptographic key that overcomes the aforementioned non-secure channel problem requires users of one or more of the devices sharing the communication channel to enter authentication information, such as a userID or userID/password combination, from which the cryptographic key may be derived (or otherwise retrieved, in cases where cryptographic keys are stored on a separate machine, such as a network server). Oftentimes, a user will be assigned or choose a userID that is similar to attributes pertaining to the user, such as the user's name, work or home location, etc. Thus, such userIDs clearly are not randomly assigned. Furthermore, since most passwords are user-selected, users will generally use passwords that are easy to remember, such as a child or pet's name, common words, or close variations thereof, rather than a cryptic password. For instance, a user might choose a password of “Ben12345” or Mariners_fan. Use of passwords of this nature may create a security risk, since many hackers use dictionary lists to “guess” userID/password combinations to access private user data and networks.

Even with the availability of cryptographic key generation/retrieval based on userIDs and passwords, etc., many users simply will not configure cryptographic keys unless the product they purchase and/or use does not operate until they take this action—and any product built in this way limits its own market viability. Yet, as discussed above, it is infeasible to provide a secure channel between devices without first establishing a cryptographic key. In one respect, this problem is more sociological than technical. As discussed above, processes for establishing an initial cryptographic key typically require users to configure userIDs and/or passwords, PIN number, or similar unique identifiers. However, people resent having the burden of remembering yet one more thing, especially to use their own property. The problem becomes even more magnified when wireless technologies are considered, since wireless communication channels are even less secure than computer network links.

Attempting to extend secure communication to lower-cost consumer devices poses additional problems. Of significant note, most of such devices do not have a keyboard or other input mechanism (e.g., keypad) by which a user can enter, userIDs, passwords, etc. As a result, the foregoing cryptographic key bootstrap mechanism is infeasible for these devices.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block schematic diagram illustrating the primary components used by a pair of devices to enable a cryptographic key to be bootstrapped between the devices in accordance with the present invention;

FIG. 2 is a time-based flowchart illustrating the operations performed on each of the devices of FIG. 1 when performing the cryptographic key bootstrap process;

FIG. 3 is a flowchart illustrating operations performed when establishing a secure communications channel using credential data transferred between the pair of devices using a short-range transfer scheme provided by the present invention; and

FIG. 4 is a flowchart illustrating details of an authentication process used when establishing the secure communications channel.

### DETAILED DESCRIPTION OF THE ILLUSTRATED EMBODIMENTS

A system and method for bootstrapping cryptographic keys that are used to enable secure communication channels between devices is described in detail herein. In the following description, numerous specific details are provided to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The present invention combines a novel, yet inexpensive short range communication channel with strong cryptographic techniques to establish an intial shared key between two devices. Rather than requiring a user to enter userIDs, passwords, etc. at each device, a key is automatically generated by a first device and sent to other devices to be shared using the short range communication channel. The shared key can then be used to establish a secure communication channel between the devices, either through direct use of the shared key, or through a cryptographic key that is generated from the shared key. As a result, there is not a need to provide a keyboard or similar user input device to establish the shared keys, and users don't need to remember userIDs and the like. Furthermore, by using the short range communications channel that is only operational for a short duration, the chance of having the shared cryptographic key stolen is extremely remote. The scheme also enables encrypted secure communication channels to be easily established without requiring users of devices that use those channels for communications purposes to enter passwords, PINs, or the like.

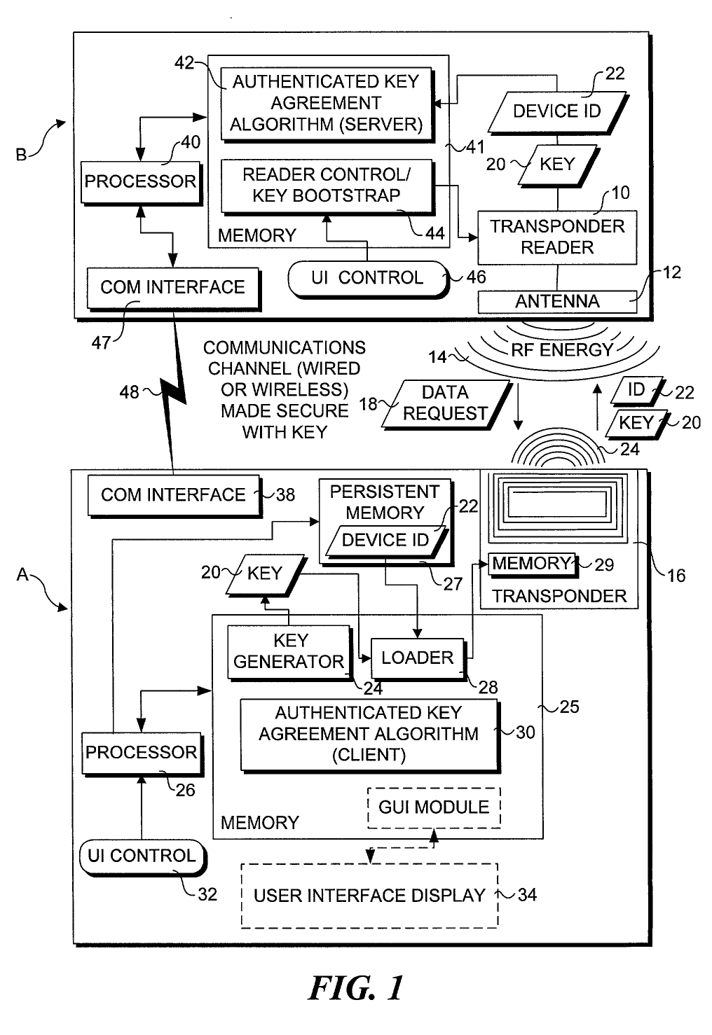

An exemplary implementation of the invention is illustrated in FIG. 1, wherein a key that is used to facilitate a secure communication channel between devices A and B is generated by device A and communicated to a device B via a short range wireless communication channel. In the illustrated embodiment, the short range wireless communication channel is enabled through use of a transponder/transponder reader pair, which includes a transponder reader 10 that drives an antenna 12 to radiate radio frequency (RF) energy 14 from a first device (depicted in FIG. 1 as device B), to a second device (e.g., device A) in which a corresponding transponder 16 is contained or attached thereto. The RF energy is used to supply operating energy to the transponder, which, in turn, is tuned to receive data at the frequency transmitted by the antenna, including a data request 18. In response to receiving radiated RF energy 14 and data request 18, transponder 16 automatically transmits selected data back to antenna 12, including a cryptographic key 20 and a device ID 22, via an RF signal 24.

In accordance with one embodiment of the invention, transponder 16 comprises a Texas Instruments “TAG-IT”™ transceiver IC, and transponder reader 10 comprises a Texas Instruments “TAG-IT”™ reader 6000 (model # RI-K013240). This particular transponder and transponder reader pair operates in the unregulated 13.56 MHz band using a data transmission rate of 27.6 Kbps, with the transponder reader generating a signal with a power level of 120 mW and a corresponding maximum range of 13 cm (5.12 inches). In addition to these components, other transponder/transponder reader components provided by Texas Instruments and other manufacturers that provide similar attributes may also be used.

Furthermore, in addition to transponder-based communication channels, other short-range wireless communication channels may be used. For example, short range wireless channels corresponding to the IEEE 802.11a and 802.11b protocols and various Bluetooth protocol may be used, as well as other protocols operating in the 2.4 GHz and 900 MHz wavebands and infrared wavelengths. However, it is noted that these other types of short-range channels are not as secure as the transponder-based channels, since their ranges are longer, which presents an opportunity for encryption information to be intercepted.

To facilitate generation and sending of key 20 device A includes a key generator 24. In one embodiment, key generator 24 comprises a software module that is stored in a memory 25 as a plurality of machine instructions that generates a random number key when executed by a processor 26. In general, in instances in which device A does not include a persistent storage device (e.g., hard drive), memory 25 will comprise a persistent memory device, such as a ROM or flash memory device, which is capable of storing data in a persistent form. If a persistent storage device is available (not shown), memory 25 may comprise a RAM component (e.g., SDRAM). In an optional configuration, key generator 24 comprises a hardware component, such as an ASIC (application-specific integrated circuit), which generates a random number based on internal programming.

Device A also includes a persistent memory device 27 in which device ID 22 is stored. (It is noted that if memory 25 comprises a persistent memory device, then device ID 22 may be stored in memory 25, and persistent memory device 27 is not required.) In one embodiment, device ID 22 comprises an 802 MAC (Media Access Control) address; however, it is noted that other similar unique identifiers may be used. For example, an IP address may be used to permit the use of the TCP/IP protocol suite.

Device ID 22 and key 20 are loaded into a memory 29 provided by or made accessible to transponder 16 via a loader software module 28 stored in memory 25. Device A also includes a client-side authenticated key agreement algorithm 30 comprising a plurality of machine instructions stored in memory 25 and an input means for enabling a user to interact with the device. In one embodiment, the input means includes a mechanical user interface control 32, such as a button. Optionally, user input may be provided via a graphical user interface (GUI) presented to the user on a user interface display 34 through use of a GUI module 35 stored in memory 25 and executed by processor 26. Device A further includes a communication interface 38, which facilitates communications with other devices, such as device B. Depending on the particular communication link to be used, communication interface 38 may support wired and/or wireless communication links. For example, communication interface 38 may comprise a computer network interface component or module or a wireless phone transceiver.

In a manner similar to device A, device B also includes a processor 40 and a memory 41 in which a plurality of machine instructions are stored, including a server-side authenticated key agreement algorithm 42 and a reader control/key bootstrap module 44. The reader control/key bootstrap module 44 may be activated via a user interface control (e.g., button) 46 to enable transponder reader 10 to transmit RF energy 14 and read external RF signals, such as RF signal 24. Optionally, a GUI-based control (not shown) may be used for this purpose. Upon reading device ID 22 and key 20, these data are forwarded from transponder reader 10 to server-side authenticated key agreement algorithm 42. Device B further includes a communication interface 47 that enables communication with other devices, such as device A, and provided functionality similar to that discussed above with reference to communication interface 38.

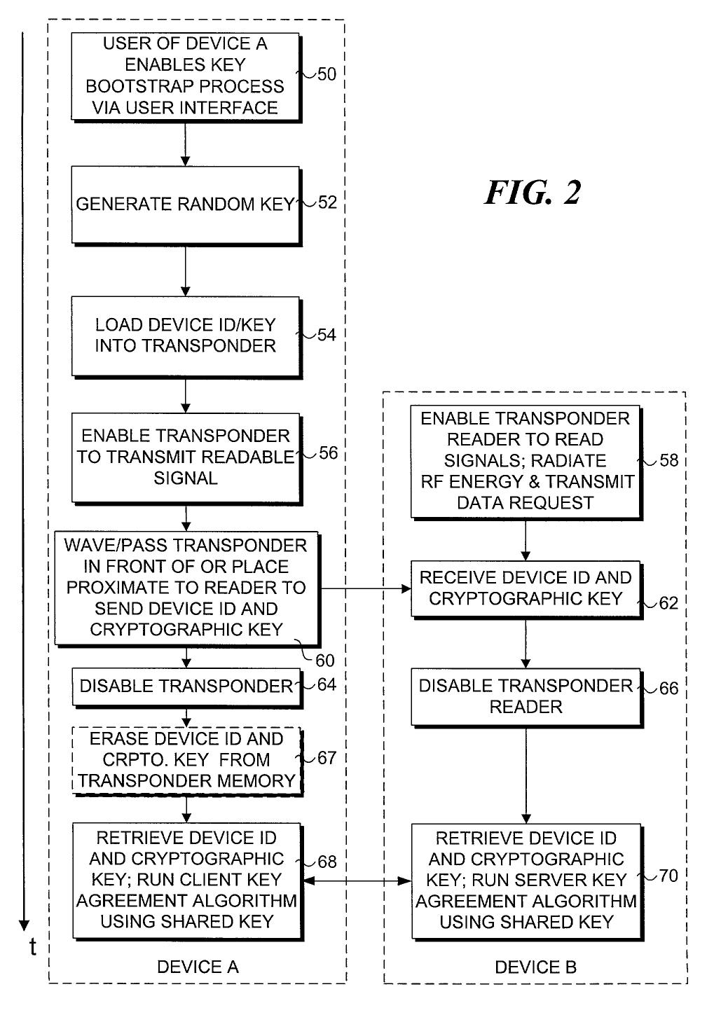

A timeline illustrating various operations performed by devices A and B during an exemplary cryptographic key bootstrap process is shown in FIG. 2. The process starts in a block 50, wherein a user of device A initiates the cryptographic key bootstrap process via activation of an appropriate user interface component or object, such as user interface control 32 (in accordance with a manual user input) or a GUI menu option or user interface control (e.g., button) displayed on user interface display 34 (in accordance with a software-based user input). A random key 20 is then generated by key generator 24 in a block 52. In one embodiment, key generator 24 generates a cryptographically secure pseudo-random number that is used for key 20. The key and device ID 22 are then loaded into transponder memory 27 via loader 28 in a block 54, which prepares the transponder to transmit a readable signal (i.e., RF signal 24) in response to detecting an appropriate data request (i.e., data request 18), as provided by a block 56.

Sometime shortly before, coincident with, or shortly after the transponder has been enabled to transmit a readable signal, a user of device B activates transponder reader 10 in a block 58. In response to being activated, transponder reader 10 drives antenna 12 to radiate a RF signal that includes RF energy 14 and data request 18, which tells any appropriately configured transponder (e.g., transponder 16) that receives the data request that the transponder reader is ready to receive transponder signals.

In a block 60, the user of device A waves or passes the transponder in front of the transponder reader, enabling device A to receive RF energy 14, which energizes transponder 16, enabling the transponder to detect data request 18. In response, transponder 16 transmits data corresponding to device ID 22 and key 20 via RF signal 24, which is received by device B via antenna 12 in a block 62. At this point, device ID 22 and key 20 have been successfully sent from device A to device B. As such, the transponder and transponder reader have performed their respective functions and can now be disabled, as provided by blocks 64 and 66, respectively. As an option, the device ID and cryptographic key may be erased from transponder memory 29 to ensure that this information cannot be “stolen” by a third party in a block 67.

As a result of the prior operations, each of devices A and B have been provided with a copy of key 20 and device ID 22. Each of these data are retrieved by respective authenticated key agreement algorithms (i.e., client-side authenticated key agreement algorithm 30 and server-side authenticated key agreement algorithm 44 for device A and device B, respectively), which comprise symmetric key authentication algorithms that are used to establish a secure communication channel 48 via communication interfaces 38 and 46 using an encrypted data communications protocol that is implemented through the use of key 20. Typically, rather than use the key 20 directly, the authenticated key agreement algorithms generate a new cryptographic key based on key 20 that may be used in an encrypted communications protocol to establish a secure communications channel. In one embodiment, the encrypted communications protocol provides forward secrecy, although this is not required. In a current prototype implementation, the Secure Remote Password (SRP, RFC 2945) is used to provide this function. Optionally, key 20 may be used directly as the key used by the encrypted communications protocol.

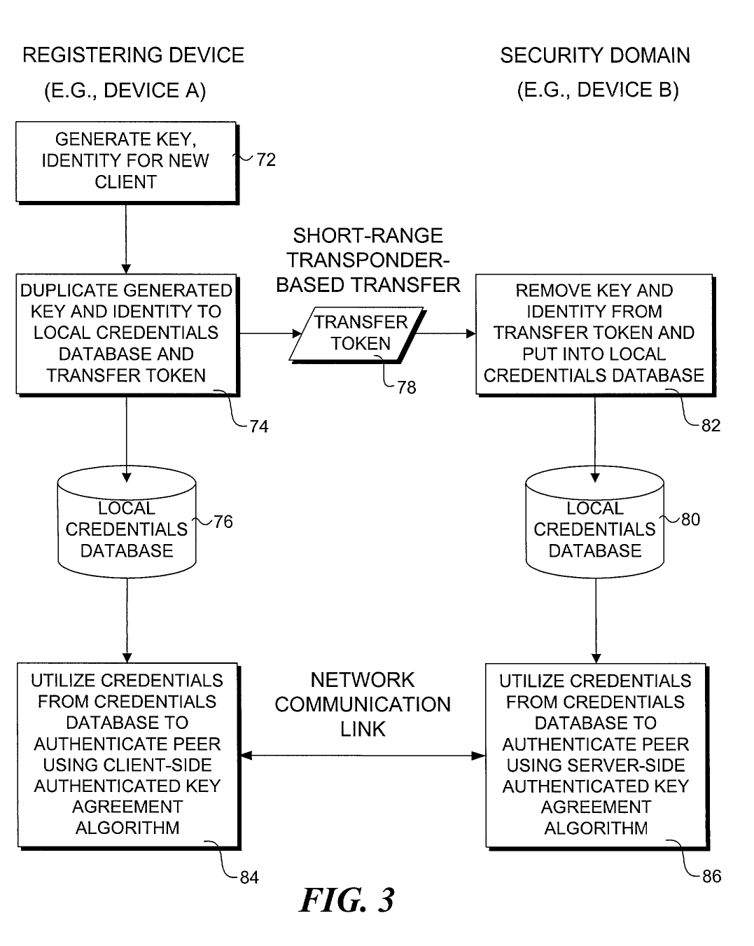

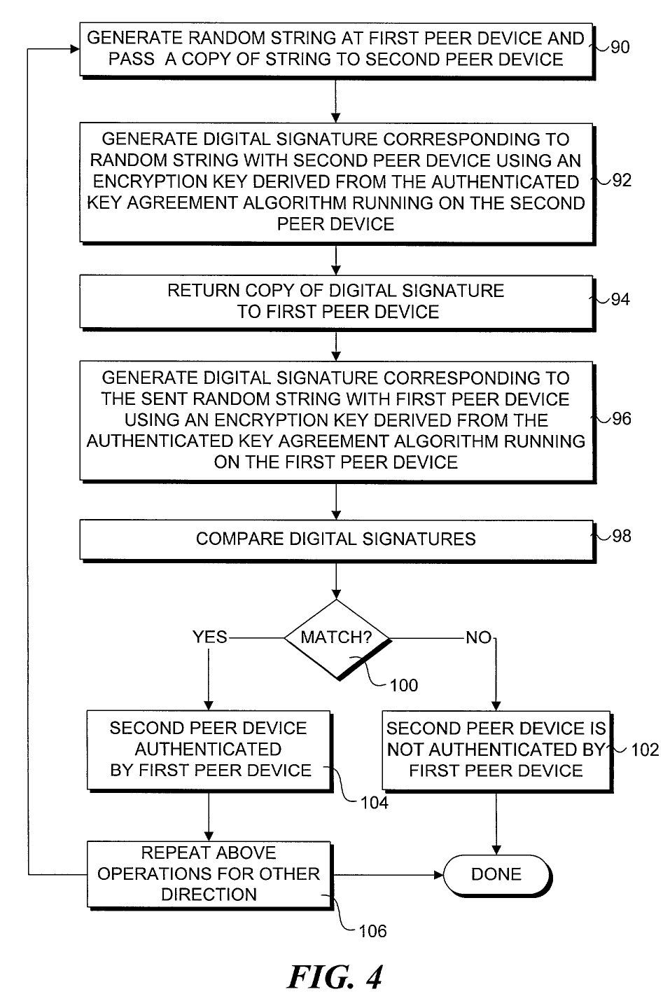

Details of an authentication process that is performed in one embodiment when establishing the communications channel are shown in FIGS. 3 and 4. In a block 72 of FIG. 3, the random key and identity for the new host device (e.g., unique device ID) is generated in the manner discussed above. The key and identity are duplicated in a block 74, with a copy being stored in a local credentials database 76 and a copy being provided to a transfer token 78. Typically, local credentials database 76 will comprise a data structure stored in the memory for the host device, such as memory 25 for device A. Data corresponding to transfer token 78 is then transmitted to the registering device (e.g., device B) using the short-range transponder-based communication link discussed above. Upon receiving the transfer token, the key and host identity are removed from the transfer token and stored in a local credentials database 80 in a block 82. Typically, local credentials database 82 will comprise a data structure stored in the memory of the registering device, such as memory 41 for device B.

At this point, both devices have a copy of the generated key and the host identity. Either the generated key or a combination of the generated key and host identity is then used to authenticate each peer device (i.e., device A is a peer device to device B and visa-versa) using symmetric authenticated key agreement algorithms running on each device, as provided blocks 84 and 86.

An exemplary peer-to-peer authentication scheme proceeds as follows, with reference to the flowchart of FIG. 4. (It is noted that in a preferred embodiment, the peer authentication scheme is performed by both devices; however, the flowchart and the following description pertains to single half of the peer-to-peer authentication). In a block 90, a first peer device generates a random string and passes a copy of the string to the second peer device. Upon receiving the random string, in a block 92 the second peer device generates a digital signature corresponding to the random string using an encryption key generated by the authenticated key agreement algorithm that it is running using the credentials stored in its local credentials database. In one embodiment, the generated key is used by the authenticated key agreement algorithm to generate the encryption key. Optionally, a combination of the generated key and the client identity may be used to generate the encryption key. As another option, the generated key may be used for the encryption key. The second peer device then sends a copy of the digital signature back to the first peer device in a block 94. Meanwhile, in a block 96, the first peer device also generates a digital signature corresponding to the random string it sent using an encryption key derived from the authenticated key agreement algorithm it is running and credentials stored in its local credentials database.

Since the authenticated key agreement algorithms are symmetric, both algorithms will use the same credentials data and will generate the same encryption keys if transfer of the transfer token was successful. If transfer was not successful, or if a non-trustworthy device is used (i.e., a device that does not run a symmetric copy of the authenticated key agreement algorithm) is used, the encryption keys will differ. Accordingly, the digital signatures are compared in a block 98, and a determination is made in a decision block 100 to whether the digital keys match. If they do not match, the second peer device is not authenticated, as provided by a block 102, and the authentication process is complete. If there is a match, the second peer device is authenticated in a block 104, and the foregoing authentication process is performed in the other direction (e.g., from the second peer device to the first peer device), as provided by a block 106, thereby completing the process.

Once the devices have been authenticated, they can communicate over communication channel 48 using an agreed to encryption key. In one embodiment, the encryption keys may be the same encryption keys generated for the digital signatures, or may be one of the encryption keys. For examples, in some communication schemes, a different encryption key is used for each direction of the communication channel. Optionally, a new encryption key can be generated by one of the devices and passed to the other device (preferably in an encrypted formatted known to the other device) and used for both directions of the communication channel.

Although the present invention has been described in connection with a preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

[image]

[image]

What is claimed is:

1. A method for bootstrapping a secure communications channel between devices, comprising:
generating a key via a first device;
establishing a short range communication channel between the first device and a second device;
sending a copy of the key from the first device to the second device via the short range communication channel to produce a shared key that is shared by both the first and second devices;
establishing a secure communication channel between the first and second devices using an encrypted communication protocol that implements an encryption scheme based on a common encryption key derived from the shared key, said secure communication channel being separate and apart from the short range communication channel.

2. The method of claim 1, further comprising sending identity information used to identify the first device from the first device to the second device, wherein the identity information is used to establish the secure communication channel.

3. The method of claim 1, further comprising disabling the short range communication channel after the copy of the key has been sent from the first device to the second device.

4. The method of claim 1, wherein the shared key comprises a cryptographically secure pseudo-random number.

5. The method of claim 1, wherein each of the first and second devices include an authenticated key agreement algorithm software component that is used to cooperatively generate the common encryption key.

6. The method of claim 1, wherein the short range communication channel comprises a transponder/transponder reader pair and wherein the transponder is operatively coupled to the first device and the transponder reader is operatively coupled to the second device.

7. The method of claim 6, wherein the transponder reader is coupled to an antenna that radiates radio frequency (RF) energy that is used to energize the transponder, further comprising waving the transponder in front of or placing the transponder in proximity to the transponder reader to energize the transponder and cause the transponder to transmit data pertaining to the key to enable the data to be read by the transponder reader via the antenna.

8. The method of claim 1, wherein the common cryptographic key is the shared key.

9. The method of claim 1, further comprising performing a peer-to-peer authentication using symmetric authenticated key agreement algorithms running on both devices and the shared key.

10. The method of claim 9, wherein the peer-to-peer authentication is implemented by performing the operations of:
storing credentials data including at least the shared key on both the first and second devices;
generating a first random string with the first device and passing the first random string to the second device;
generating a first digital signature corresponding to the first random string with the first device using an encryption key derived from the credentials data stored on the first device and a symmetric authenticated key agreement algorithm running on the first device;
generating a second digital signature corresponding to the first random string with the second device using an encryption key derived from the credentials data stored on the second device and a symmetric authenticated key agreement algorithm running on the second device;
comparing the first and second digital signatures to see if they match; and
authenticating the second device with the first device if there is a match.

11. The method of claim 10, wherein the peer-to-peer authentication further comprises performing the operation of:
generating a second random string with the second device and passing the second random string to the first device;
generating a third digital signature corresponding to the second random string with the second device using an encryption key derived from the credentials data stored on the second device and a symmetric authenticated key agreement algorithm running on the second device;
generating a fourth digital signature corresponding to the second random string with the first device using an encryption key derived from the credentials data stored on the first device and a symmetric authenticated key agreement algorithm running on the first device;
comparing the third and fourth digital signatures to see if they match; and
authenticating the first device with the second device if there is a match.

12. A method for bootstrapping a secure communications channel between devices, comprising:
generating a key via a first device;
activating a transponder reader in a second device;
transmitting data corresponding to a copy of the key from a transponder operatively coupled to the first device to the transponder reader;
storing the copy of the key in the second device to produce a shared key that is shared by both the first and second devices;
establishing a secure communication channel between the first and second devices using an encrypted communication protocol that implements an encryption scheme based on a common encryption key derived from the shared key.

13. The method of claim 12, further comprising disabling at least one of the transponder and transponder reader after the copy of the key has been sent from the first device to the second device.

14. The method of claim 12, wherein the transponder reader is coupled to an antenna that radiates radio frequency (RF) energy that is used to energize the transponder, further comprising waving the transponder in front of or placing the transponder in proximity to the transponder reader to energize the transponder and cause the transponder to transmit a signal containing the data corresponding to the copy of the key to enable the data to be read by the transponder reader via the antenna.

15. The method of claim 14, wherein the transponder reader further transmits data via the antenna requesting the transponder to send data to the transponder reader and the transponder sends the data corresponding to the copy of the key in response to receiving the request.

16. The method of claim 12, wherein the transponder comprises a transceiver that sends and receives data using a 13.56 MHz radio frequency signal.

17. A device comprising:
a processor;
a transceiver to receive and send data via radio frequency RF signals;
a key generator operatively coupled to the transceiver and the processor;
a communication interface to send and receive data from an external device via a communication link; and
a memory coupled to the processor in which a plurality of machine instructions including an authenticated key agreement algorithm module are stored that when executed by the processor performs the operations of:
invoking the key generator to generate a key;
passing a copy of the key to the transceiver;
enabling the transceiver to send a copy of the key to the external device via a first RF signal to share the key between the device and the external device; and
establishing a secure communication channel with the second device over the communication link that uses a cryptographic key that is generated through execution of the authenticated key agreement algorithm module in cooperative interaction with a symmetrical key agreement algorithm operating on the external device and is based on the key that is shared between the device and the external device.

18. The device of claim 17, wherein the transceiver comprises a transponder that transmits the first RF signal containing data corresponding to the copy of the key in response to receiving a second RF signal containing a data request from the external device.

19. The device of claim 18, wherein the transponder is energized to transmit the first RF signal by receiving RF energy via the second RF signal sent by the external device.

20. The device of claim 17, further comprising a user interface control, coupled to the processor, to receive a user request to establish a secure communication channel between the device and the external device.

21. The device of claim 17, further comprising a persistent memory device in which a device identifier is stored, and wherein execution of the machine instructions by the processor further performs the operation of sending data corresponding to the device identifier to the external device via the first RF signal.

22. A device comprising:
a processor;
a transceiver to receive and send data via radio frequency (RF) signals;
a communication interface to send data to and receive data from an external device via a communication link; and
a memory coupled to the processor in which a plurality of machine instructions including an authenticated key agreement algorithm module are stored that when executed by the processor performs the operations of:
controlling the transceiver to enable the transceiver to receive a copy of a shared key from the external device via a first RF signal; and
establishing a secure communication channel with the external device over the communication link, wherein the secure communication channel uses a cryptographic key that is generated through execution of the authenticated key agreement algorithm module through cooperative interaction with a symmetrical key agreement algorithm operating on the external device and is based on the shared key.

23. The device of claim 22 wherein the transceiver comprises a transponder reader to receive an RF signal generated by a compatible transponder that is operatively coupled to the external device.

24. The device of claim 23, further comprising an antenna coupled to the transponder reader and driven by the transponder reader to generate an RF signal including RF energy that is received by the compatible transponder to energize the compatible transponder.

25. The device of claim 22, further comprising a user interface control, coupled to the processor, to receive a user request to establish a secure communication channel between the device and the external device.
